(19) United States
(12) Patent Application Publication
(10) Pub. No.: US 2017/0111409 A1
(43) Pub. Date: Apr. 20, 2017

(54) TRANSMISSION TERMINAL, AUTOMATIC RESPONSE METHOD, AND RECORDING MEDIUM

(71) Applicant: Atsushi KOKUBO, Kanagawa (JP)

(72) Inventor: Atsushi KOKUBO, Kanagawa (JP)

(21) Appl. No.: 15/294,104

(22) Filed: Oct. 14, 2016

(30) Foreign Application Priority Data
Oct. 19, 2015 (JP) 2015-205771

(51) Int. Cl. H04L 29/06; H04W 72/04

(52) U.S. Cl. CPC H04L 65/403; H04W 72/048

(57) ABSTRACT

Disclosed is a transmission terminal for use in transmission of content data in response to a start request for starting the transmission of the content data from an external terminal. The transmission terminal includes a memory and one or more processors programmed to execute a process including determining whether the transmission terminal is coupled to a predetermined external apparatus, and transmitting a response to the start request, when the transmission terminal is determined to be coupled to the predetermined external apparatus.

### CROSS-REFERENCE TO RELATED APPLICATIONS

The present application claims the benefit of priority under 35 U.S.C. §119 of Japanese Patent Application No. 2015-205771, filed on Oct. 19, 2015, the contents of which are incorporated herein by reference in their entirety.

### BACKGROUND OF THE INVENTION

1. Field of the Invention

The present disclosure relates to a transmission terminal, an automatic response method, and a recording medium storing a program.

2. Description of the Related Art

TV conference systems are widely spread technologies configured to conduct a TV conference between transmission terminals at multiple locations via communications networks such as the Internet or a local area network (LAN). Amongst the TV conference systems, there is a TV conference system known in the art that allows a user to operate a robot from a remote location in order to move the robot to have conversation with people or to participate in a TV conference without the user's leaving for the conference site. The above-described robot for use in the TV conference system may be called a “telepresence robot”, for example.

In addition, Japanese Patent No. 2974730, for example, discloses a technology to automatically respond to an incoming call when receiving the incoming call from a preset terminal at a preset conference time.

### RELATED ART DOCUMENT

### Patent Document

Patent Document 1: Japanese Patent No. 2974730

### SUMMARY OF THE INVENTION

Accordingly, it is a general object in one embodiment of the present invention to provide technology capable of simply transmitting a response to a transmission start request for starting transmission of content data.

According to an aspect of embodiments, there is provided a transmission terminal for use in transmission of content data in response to a start request for starting the transmission of the content data from an external terminal. The transmission terminal includes a memory and one or more processors programmed to execute a process including determining whether the transmission terminal is coupled to a predetermined external apparatus; and transmitting a response to the start request, when the transmission terminal is determined to be coupled to the predetermined external apparatus.

Other objects, features and advantages of the present invention will become more apparent from the following detailed description when read in conjunction with the accompanying drawings.

### BRIEF DESCRIPTION OF THE DRAWINGS

FIG. 1 is a diagram illustrating a configuration example of a communications system according to an embodiment;

FIG. 2 is a diagram illustrating a hardware configuration example of a terminal;

FIG. 3 is a diagram illustrating a hardware configuration example of a management system and a relay apparatus;

FIG. 4 is a diagram illustrating a hardware configuration example of a moving apparatus;

FIG. 5 is a diagram illustrating a functional configuration example of the communications system;

FIG. 6 is a diagram illustrating another functional configuration of an automatic response processor of the terminal;

FIG. 7 is a diagram illustrating an example of a time period information management table;

FIG. 8 is a diagram illustrating an example of a setting screen for setting an automatic response allowable flag;

FIG. 9 is a table illustrating an example of information managed by the management system;

FIGS. 10A to 10C are tables illustrating examples of information managed by the management system;

FIGS. 11A and 11B are tables illustrating examples of information managed by the management system;

FIG. 12 is a sequence diagram of the communications system that transmits an automatic response to the transmitted start request;

FIG. 13 is a flowchart illustrating the automatic response determining process;

FIG. 14 is a sequence diagram illustrating an example of a preparatory process of the communications system;

FIG. 15 is a sequence diagram illustrating a detailed example of a communications process of the communications system; and

FIG. 16 is a diagram illustrating an example of a display screen of the terminal.

### DETAILED DESCRIPTION OF THE PREFERRED EMBODIMENTS

According to the related art TV conference system, the transmission terminal may, for example, fail to respond to a start request for starting to transmit content data when the transmission terminal receives the start request via a TV conference unless the transmission terminal is operated by some user near the transmission terminal or unless the transmission terminal sets a conference time in advance.

The following illustrates embodiments of the present invention with reference to the accompanying drawings. The following embodiments are only examples and therefore the embodiments of the present invention are not limited to these examples.

Note that in the drawings, components having the same functions are provided with the same reference numbers, and a duplicated description is omitted from the specification.

### System Configuration

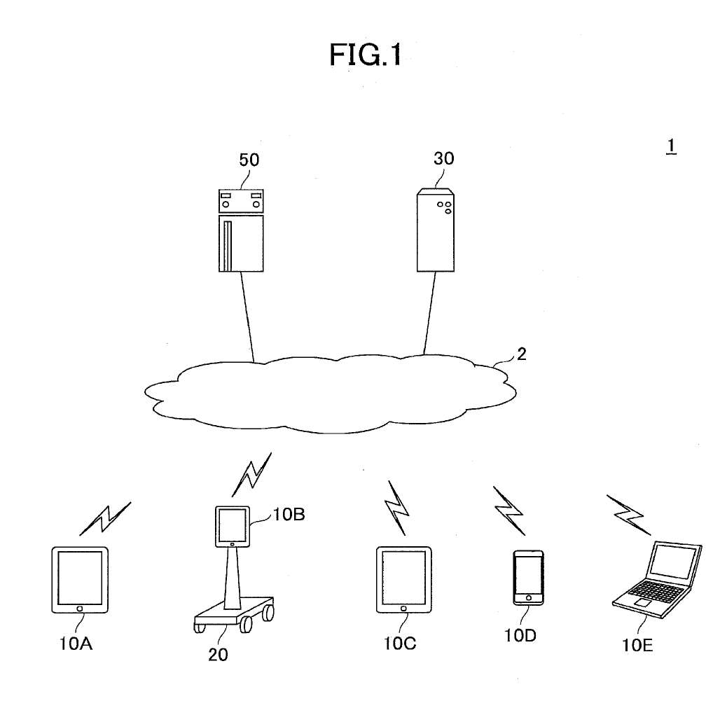

FIG. 1 is a diagram illustrating a configuration example of a communications system 1 according to an embodiment. The communications system 1 includes two or more terminals 10A, 10B, 10C, 10D and 10E, a moving apparatus 20, a relay apparatus 30, and a management system 50. Note that any one of the terminals 10A, 10B, 10C, 10D and 10E may be referred to as a “terminal 10” in the following description. Note also that the number of terminals 10 illustrated in FIG. 1 is merely an example.

The terminal 10, the relay apparatus 30, and the management system 50 are communicatively coupled to other terminals, apparatuses, and systems via a communications network 2. The communications network 2 15may, for example, include local area networks (LANs), the Internet, mobile telephone networks, or dedicated lines.

The terminal (transmission terminal) 10 may be a general purpose computer such as a tablet terminal, a smartphone and a personal computer (PC), or a special purpose computer such as a TV conference apparatus. The terminal 10 may conduct a TV conference or the like by transmitting to or receiving from one or more other terminals image data, audio data, and the like.

In. FIG. 1, the terminal 10B is communicatively coupled to the moving apparatus 20 wirelessly or via a wire to control a moving function of the moving apparatus 20 by executing an application program (hereinafter called an “application”) corresponding to the communications system 1. Alternatively, the terminal 10B may be a movable terminal 10 incorporating the moving apparatus 20.

Another the terminal 10 such as the terminal 10A may be able to conduct a TV conference with the terminal 10B and remotely control the moving apparatus 20 via the terminal 10B by executing the applications corresponding to the communications system 1. For example, the terminal 10A may be able to move the moving apparatus 20 incorporating the terminal 10B forward, backward, leftward, or rightward by operating the operation buttons displayed on the display screen of the TV content data.

The moving apparatus 20 is an apparatus that perform a moving function such as “moving forward”, “moving backward”, “turning clockwise”, and “turning counter-clockwise” by driving wheels or legs of the moving apparatus 20 in accordance with control from the terminal 10B attached to the moving apparatus 20. The external view of the moving apparatus 20 illustrated in FIG. 1 is merely an example. The moving apparatus 20 may be able to move along with the terminal 10B in accordance with control information from the terminal 10B attached to the moving apparatus 20. Note that the moving apparatus 20 is an example of an apparatus controlled the terminal 10B. Note also that the moving apparatus 20 and the terminal 10B may be formed as separate entities that are wirelessly coupled or coupled via a cable, or may be formed as an integrated apparatus.

The relay apparatus 30 may be an information processing apparatus or a system having one or more information processing apparatuses that may relay content data transmitted and received between the terminals 10.

The management system (a communications management system) 50 may be an information processing apparatus or a system having one or more information processing apparatuses. The management system 50 may, for example, be configured to manage login authentication from the terminals 10, manage communications statuses of the terminals 10, manage a list of destinations (destination list), and control sessions to perform communications between the terminals 10 via the relay apparatus 30.

In one embodiment, a session may be implemented by causing the relay apparatus 30 to relay content data including the image data and audio data between the terminals 10.

In the above configuration, a user of the terminal 10A performs communications with the terminal 10B to move the terminal 10B and the moving apparatus 20 by remote operations. The user of the terminal 10A may be able to move the terminal 10B and the moving apparatus 20 close to a desired one of users to conduct a TV conference.

In this embodiment, the terminal 10 determines whether the terminal 10 is coupled to a predetermined external apparatus (e.g., the moving apparatus 20) when the terminal 10 receives the start request to start transmitting content data for the TV conference. When the terminal 10 is coupled to the predetermined external apparatus, the terminal 10 transmits an automatic response, in response to the start request.

Note that in this embodiment, an illustration is given of the communications system 1, the management system 50, and the terminal 10, on the basis of anticipating a TV conference system as being an example of a communications system, a TV conference management system as being an example of a communications management system, and a TV conference terminal as being an example of a communications terminal. That is, the terminal 10 and the management system 50 are not only applied to the TV conference system but are also applied to other communications systems. For example, the communications system 1 may be a telephone system, the terminal 10 may be a mobile terminal including an Internet protocol (IP) phone, an Internet phone, a personal computer (PC), a notebook PC, a smartphone, and a tablet terminal.

In the following embodiments, the “TV conference” and “video conference” are interchangeably used.

### Hardware Configuration

### Hardware Configuration of Terminal

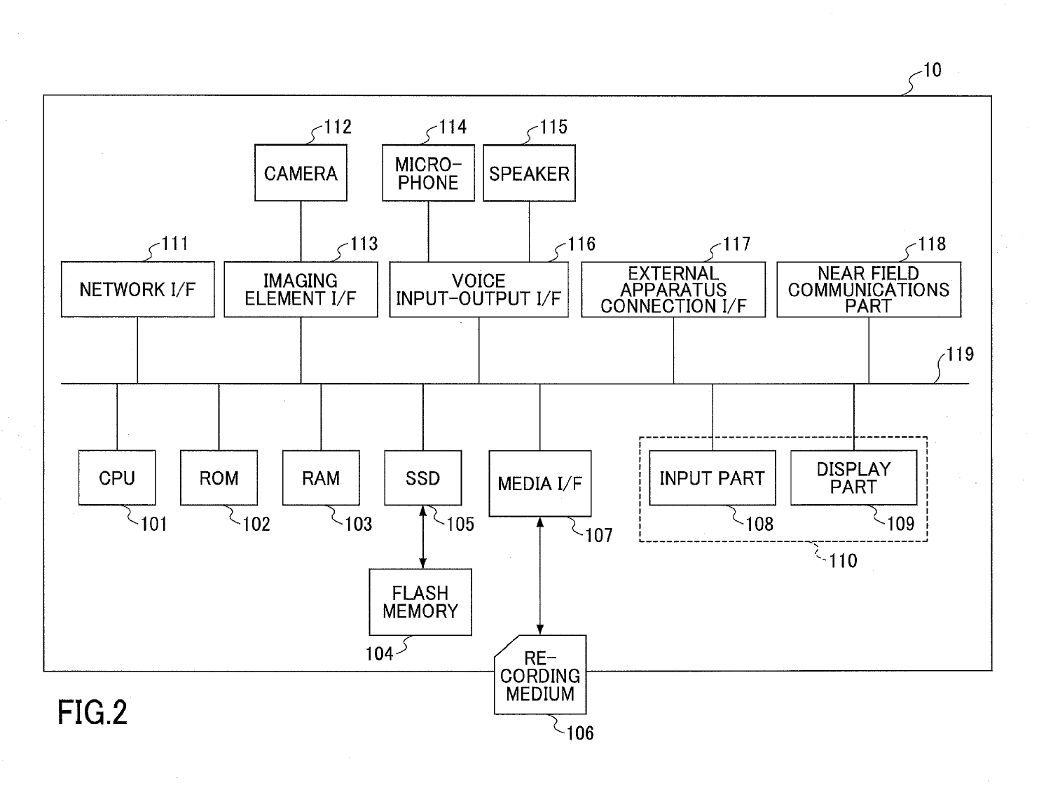

FIG. 2 is a diagram illustrating a hardware configuration example of the terminal 10. The terminal 10 has a general-purpose computer configuration. For example, the terminal 10 includes a central processing unit (CPU) 101, a read only memory (ROM) 102, a random access memory (RAM) 103, a flash memory 104, and a solid state drive (SSD) 105. The terminal 10 further includes a media interface (I/F) 107, an input part 108, a display part 109, a network I/F 111, a camera 112, an imaging element I/F 113, a microphone 114, a speaker and a voice input-output I/F 116. Moreover, the terminal 10 includes an external apparatus connection I/F 117, a near field communications part 118, and a bus 119.

The CPU 101 may be an operational unit configured to read programs from the ROM 102 or the flash memory 104 and execute the read programs to implement respective functions of the terminal 10. The ROM 102 may be a nonvolatile memory storing in advance programs or the like for use in activating the CPU 101 such as an initial program loader (IPL). The RAM 103 may be a volatile memory used as a work area or the like of the CPU 101.

The flash memory 104 may be a storage device storing an operating system (OS), application programs, and various types of data. The SSD 105 may be configured to control reading or writing of various types of data with respect to the flash memory 104 in accordance with the control of the CPU 101. The media I/F 107 may be configured to control reading or writing (storing) of data with respect to a recording medium 106 such as a memory card.

The input part 108 may be an input device configured to receive input operations from a user of a touch panel, a keyboard, or a pointing device. The display part 109 may he a display device configured to present various types of displays addressed to the user. Note that the input part 108 and the display part 109 may be integrated to form a display input part 110 such as a touch panel display or the like that integrates a touch panel and a display.

The network I/F 111 may be a communications interface via which the terminal 10 transmits data using the communications network 2. The camera 112 includes an imaging element configured to image a subject in accordance with control of the CPU 101. The imaging element I/F 113 may be configured to convert the imaged data into predetermined image data while controlling the imaging by the camera 112. The microphone 114 may be configured to convert collected voice or sound into electric signals. The speaker 115 may be configured to convert the audio signals into voice or sound. The voice input-output I/F 116 may be configured to control audio input and output via the microphone 114 and the speaker 115.

The external apparatus connection I/F 117 may be an interface configured to couple the terminal 10 to the external apparatus via a universal serial bus (USE). An example of the external apparatus may include the moving apparatus 20 illustrated in FIG. 1, for example.

The near field communications part 118 may be a communications interface for allowing the terminal 10 to perform communications with the external apparatus (e.g., the moving apparatus 20) via near field communications such as Bluetooth (registered trademark) and Bluetooth low energy. The bus 119 may be mutually coupled to the above-described components, and may propagate signals including address signals, data signals, and various types of control signals.

### Hardware Configuration of Management System and Relay Apparatus

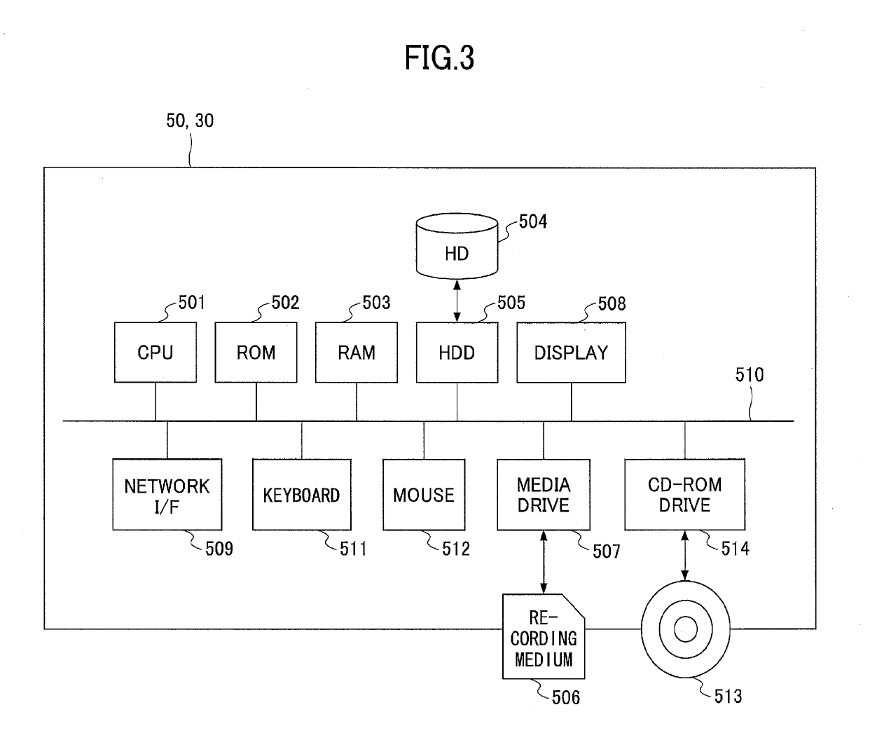

FIG. 3 is a diagram illustrating a hardware configuration example of the management system 50. The management system 50 has a general-purpose computer configuration. For example, the management system 50 includes a CPU 501, a ROM 502, a RAM 503, a HD 504, a hard disk drive (HDD) 505, a media drive 507, and a display 508. The management system 50 further includes a network I/F 509, a keyboard 511, a mouse 512, a CD-ROM drive 514, and a bus 510

The CPU 501 may be an operational unit configured to read programs from the ROM 502 or the HD 504 and execute the read programs to implement respective functions of the management system 50. The ROM 502 may be a nonvolatile memory storing in advance programs or the like for use in activating the CPU 501 such as an IPL. The RAM 503 may be a volatile memory used as a work area or the like of the CPU 501.

The HD 504 may be a storage device storing programs including an OS and application programs, and various types of data. The HDD 505 may be configured to control reading or writing of various types of data with respect to the HD 504 in accordance with the control of the CPU 501. The display 508 may be a display device configured to display various types of information including a cursor, menus, windows, characters, or images.

The network I/F 509 is may be a communications interface via which the management system 50 transmits data using the communications network 2. The keyboard 511 may be an example of an input device configured to receive input operations including characters, numeric values, various types of instructions input by the user. The mouse 512 may be an example of a pointing device configured to receive operations including the user's selection or execution of various types of instructions, selection of a process target, and moving a cursor from the user.

The media drive 507 may be configured to control reading or writing (storing) of data with respect to a recording medium 506 such as a memory card. The CD-ROM drive 514 may be configured to control reading or writing of data with respect to a disk 513 as an example of a removable recording medium. The bus 510 may electrically be coupled to the above-described components, and may propagate signals including address signals, data signals, and various types of control signals.

Note that the above-described hardware configuration of the computer is merely an example. For example, the display 508, the keyboard 511, and the mouse 512 may be externally attached outside the management system 50.

The relay apparatus 30 may have a hardware configuration similar to the hardware configuration of the management system 50. Note that respective programs specific to the terminal 10, the relay apparatus 30 and the management system 50 may be distributed in a form of the above-described computer-readable recording medium storing the programs in files of an installable format or executable format. Examples of the recording medium include a compact disc recordable (CD-R), a digital versatile disk (DVD), and a Blu-ray disc. The recording media such as a CD-ROMs recording various types of programs and the HD 504 storing the programs may be distributed domestically or internationally as program products.

### Hardware Configuration of Moving Apparatus

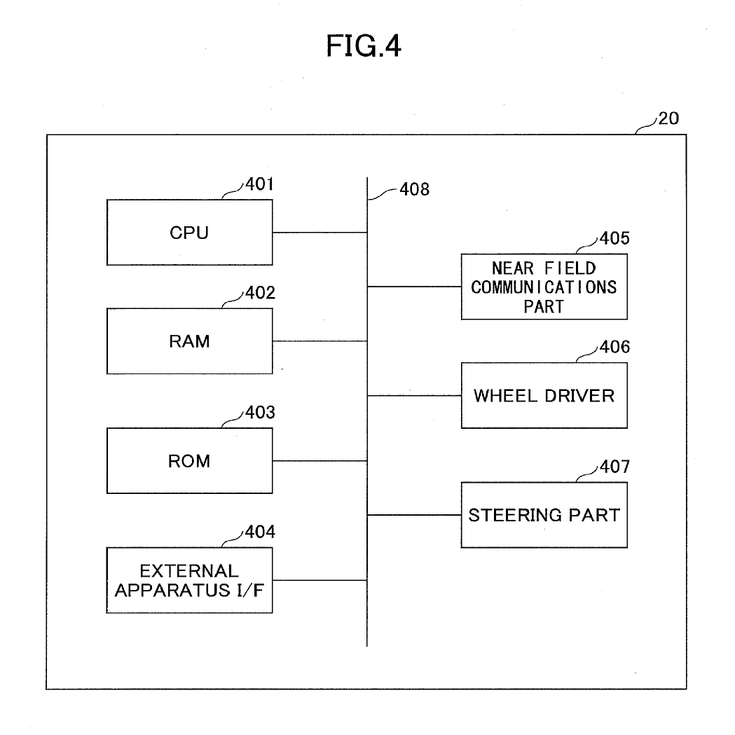

FIG. 4 is a diagram illustrating a hardware configuration example of the moving apparatus 20. The moving apparatus 20 includes a CPU 401, a RAM 402, a ROM 403, an external apparatus 1/F 404, a near field communications part 405, a wheel driver 406, and a steering part 407.

The CPU 401 may be an operational unit configured to execute programs stored in the ROM 403 to implement respective functions of the moving apparatus 20. The RAM 402 may be a volatile memory used as a work area of the CPU 401. The ROM 403 may be a nonvolatile memory storing programs and the like of the moving apparatus 20. The ROM 403 may be nonvolatile rewritable memory such as a flash ROM.

The external apparatus I/F 404 may be a wired communications interface coupled to the external apparatus connection I/F 117 of the terminal 10 via a wire illustrated in FIG. 2 to perform communications with the terminal 10.

The near field communications part 405 may be a wireless communications interface to perform wireless communications by a wireless communications system the same as the wireless communications system employed by the near field communications part 118 of the terminal 10 illustrated in FIG. The moving apparatus 20 may be configured to perform communications with the terminal 10 via the external apparatus I/F 404 or the near field communications part 405.

The wheel driver 406 may be an example of drive device configured to drive the wheels for moving the moving apparatus 20. The wheel driver 406 may include a motor or the like.

The steering part 407 may be an example of steering device configured to steer the moving apparatus 20 moved by the wheel driver 406. The steering part 407 may be configured to change directions of the wheels, or change directions of the moving apparatus 20 by controlling the rotational speeds of the wheels.

### First Embodiment

### Functional Configuration

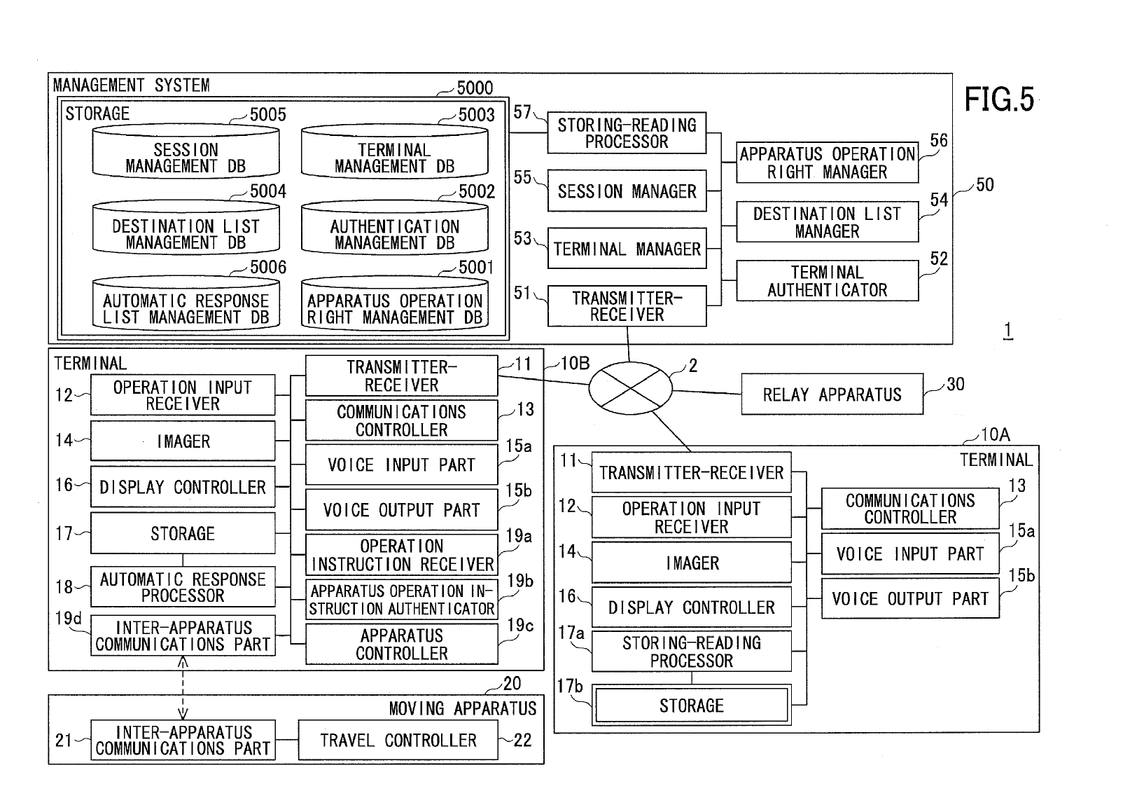

FIG. 5 is a diagram illustrating a functional configuration of a communications system according to a first embodiment.

### Functional Configuration of Terminal 10A

The terminal 10A may be an example of a terminal 10 having no function to control an apparatus such as a moving apparatus 20.

The terminal 10A includes a transmitter-receiver 11, an operation input receiver 12, a communications controller 13, an imager 14, a voice input part 15a, a voice output part 15b, a display controller 16, a storing-reading processor 17a and a storage 17b. The above-described components are functions or functional units implemented by causing any one of the components illustrated in FIG. 2 to operate on instructions from the CPU 101 in accordance with terminal 10-specific programs loaded from the flash memory 104 in the RAM 103.

### Functional Configuration of Terminal 10B

The terminal 10B may be an example of a terminal 10 having a function to control an apparatus such as a moving apparatus 20. The terminal 10B includes an operation instruction receiver 19a, an apparatus operation instruction authenticator 19b, an apparatus controller 19c, and an inter-apparatus communications part 19d, in addition to the components of the terminal 1A.

### Functional Configuration of Terminal 10

The following illustrates details of a functional configuration of the terminal 10 (terminal 10A and terminal 10B). Note that the illustration given below also includes a relationship between the main components among those components illustrated in FIG. 2 for implementing the respective functional configurations of the terminals 10A and 10B.

The transmitter-receiver 11 of the terminal 10 is implemented by instructions from the CPU 101 illustrated in FIG. 2, and is configured to perform transmission and reception of various types of data (or information) with other terminals, apparatuses, or systems via the communications network 2. The transmitter-receiver 11 starts receiving status information indicating a status of each of the transmission terminals 10 serving as destination candidates from the management system 50 before starting communications with a desired destination terminal. The status information of the terminal 10 indicates further includes detailed statuses such as a communications a capable status, a currently communicating status, or the like when the operating status is the Online status in addition to an operating status item (i.e., Online, status or Offline status) of the terminals 10.

The operation input receiver 12 of the terminal 10 is implemented by instructions from the CPU 101 illustrated in FIG. 2, and is configured to receive various types of input from a user. For example, when a user operates the input part 108 or the like to switch the power of the terminal 10 ON, the operation input receiver 12 illustrated in FIG. 5 accepts that operation to control the power to be switched ON.

The communications controller 13 of the terminal 10 is implemented by instructions from the CPU 101 illustrated in FIG. 2. The communications controller 13 is configured to automatically transmit login request information indicating a request for logging in and a current IP address of the request source terminal from the transmitter-receiver 11 to the management system 50 via the communications network 2. When the user operates the power of the terminal 10 to be switched OFF, the transmitter-receiver 11 transmits the status information indicating the power to be switched OFF to the management system 50, and the operation input receiver 12 subsequently switches the power OFF. Hence, the management system 50 may be able to detect a status change from the power ON status to the power OFF status of the terminal 10.

The communications controller 13 is further configured to perform various types of communications controls including establishing or decoupling the communications session to perform transmission and reception of the content data with another terminal 10 via the relay apparatus 30. Note that the communications controller according to the first embodiment includes a terminal identification (ID) of the terminal 10 in session control information (e.g., later-described start request information and start response information) to transmit the terminal ID of the terminal 10 to the management system 50.

The terminal ID is an example of an account that is allowable to participate in a content data transmission session using the terminal 10. The terminal ID may be a user ID serving as identification information of the user, an application ID serving as identifier information of the application, or a contract ID serving as identifier information of a contractor of the terminal 10.

The imager 14 of the terminal 10 illustrated in FIG. 5 is implemented by instructions from the CPU 101 illustrated in FIG. 2 in addition to the camera 112 and the imaging element I/F 113 illustrated in FIG. 2. The imager 14 is configured to convert image data obtained by imaging a subject into predetermined image (video) data to output the converted image (video) data.

The voice input part 15a of the terminal 10 illustrated in FIG. 5 is implemented by instructions from the CPU 301 illustrated in FIG. 2 and the voice input-output I/F 116 illustrated in FIG. 2. The voice input part 15a convers voice signals converted from the voice of the user via the microphone 114 into predetermined voice data and outputs the converted voice data. The voice output part 15b of the terminal 10 illustrated in FIG. 5 is implemented by instructions from the CPU 101 illustrated in FIG. 2 and the voice input-output I/F 116 illustrated in FIG. 2. The voice output part 15b is configured to convert voice data into voice signals and output the voice signals to the speaker 115, thereby causing the speaker 115 to output voice.

The display controller 16 of the terminal 10 is implemented by instructions from the CPU 101 illustrated in FIG. 3. The display controller 16 is configured to display image data included in the content data received by the terminal 10 on the display part 109 or the display input part 110, for example. Further, the display controller 16 is configured to transmit destination list information received from the management system 50 to the display part 109, thereby causing the display part 109 to display a destination list.

The storage 17 is configured to store authentication information such as the above-described terminal ID and a password corresponding to the terminal ID. The storage 17 may also store various types of information reported from the management system 50 (e.g., an operation right and a transfer right) in association with the operation right of the terminal 10B and the moving apparatus 20. The storage 17 may further overwrite image data and voice data received for making a phone call with a destination terminal every time the storage 17 receives the image data and the voice data. Among the above-described data, the display part 109 displays images based on the image data before being overwritten and the speaker 115 outputs voice based on the voice data before being overwritten.

Note that the terminal ID, a later-described relay apparatus ID and the like indicate examples of identifier information such as languages, characters, signs or various types of symbols for uniquely identifying the terminals 10 or the relay apparatuses 30. The terminal ID and the relay apparatus ID may be identification information having a combination of at least two of the above-described languages, characters, signs and symbols.

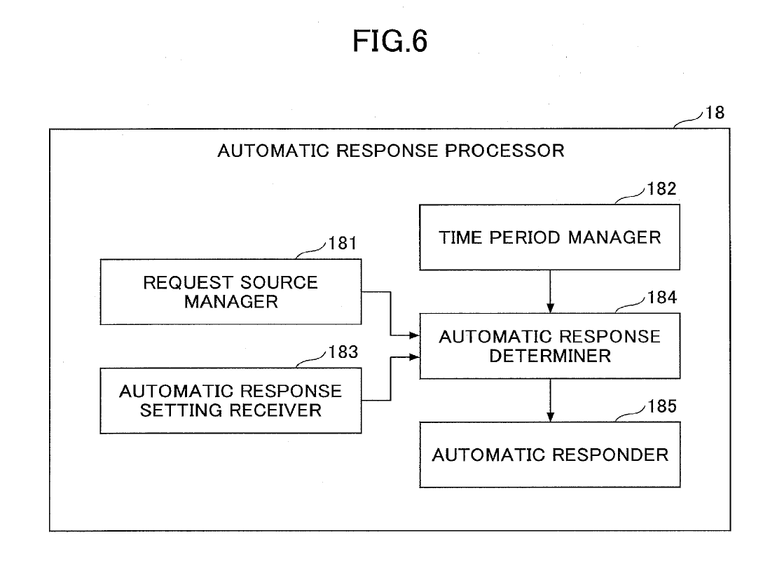

The automatic response processor 18 of the terminal 10 is implemented by instructions from the CPU 101 illustrated in FIG. 2. The automatic response processor 18 includes a request source manager 181, a time slot manager 182, an automatic response setting receiver 183, an automatic response determiner 184, and an automatic responder 185, as illustrated in FIG. 6. FIG. 6 is a diagram illustrating an example of a functional configuration of the automatic response processor 18 of the terminal 10.

The request source manager 181 is configured to store a list of automatic response allowable terminals (hereinafter called am “automatic response allowable terminal list”) including the terminal IDs of other terminals 10 in the storage 17, for example. The automatic response allowable terminal list may be acquired from the management system 50 when the terminal 10 logs into the management system 50, or may be set by the user's setting operation or the like using the operation input receiver 12. The automatic response allowable terminal list may be a list of the terminal IDs such ad “01ab”, “01ac”, and the like of the request source terminals that are allowed to use the automatic response.

The time slot manager 182 is configured to store time slots or time periods to which the automatic response (hereinafter called an “automatic response specifying time”) is applied in the storage 17, for example. The automatic response specifying time slots or time periods may be acquired from the management system 50 when the terminal 10 logs into the management system 50, or may be set by the user's setting operation or the like using the operation input receiver 12.

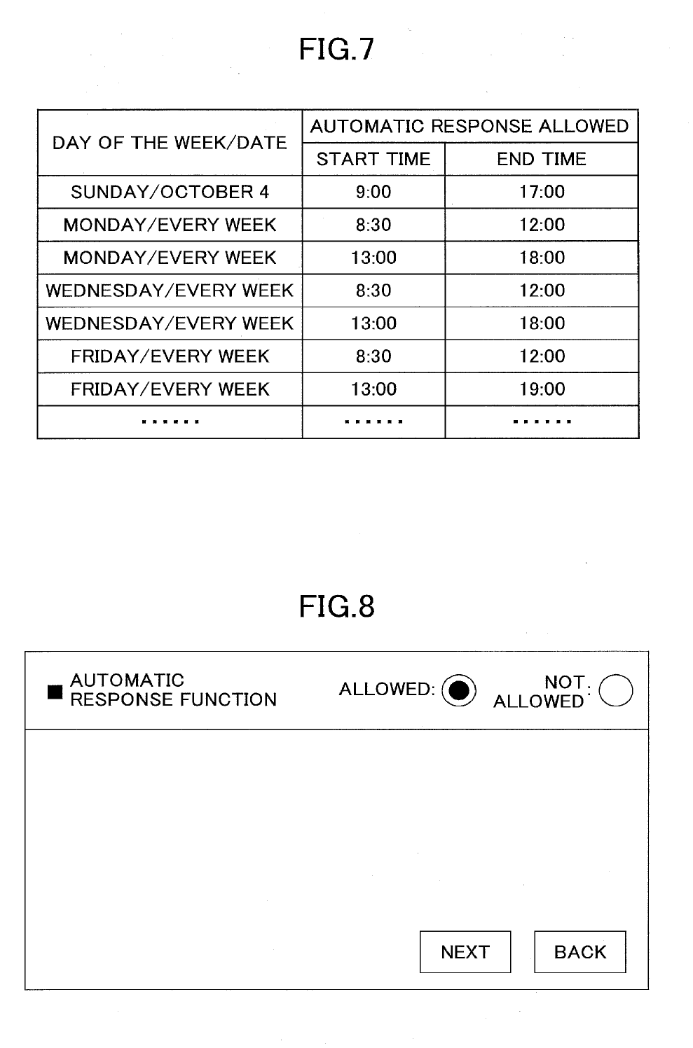

FIG. 7 is a diagram illustrating an example of a time slot information management table having information on automatic response allowable time slots stored by the time slot manager 182 in the storage 17. In the example of the time slot information management table illustrated in FIG. 7, date or a day of the week on which the automatic response is conducted is managed in association with a start time and an end time of a time slot in which the automatic response is performed.

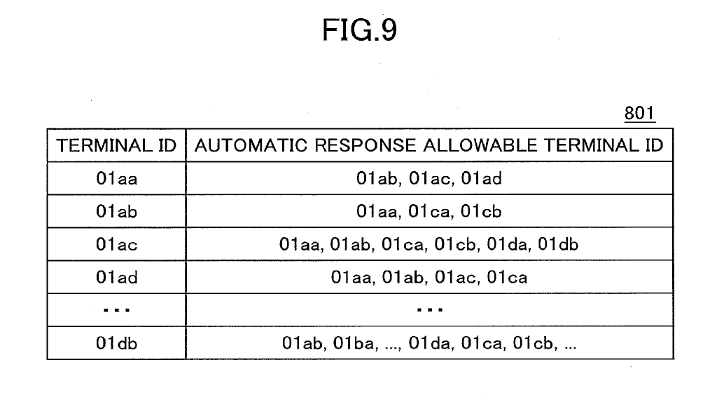

The automatic response setting receiver 183 is configured to cause the later-described automatic response determiner 184 to determine whether the terminal 10 is coupled to a predetermined external apparatus when the automatic response setting receiver 183 receives a predetermined operation from the user. Subsequently, when the automatic response determiner 184 determines that the terminal 10 is coupled to the predetermined external apparatus, the automatic response setting receiver 183 displays, for example, a setting screen illustrated in FIG. 8 and receives an automatic response allowable flag specifying whether to allow the automatic response in accordance with the user's operation or the like of the operation input receiver 12.

When the automatic response determiner 184 determines that the terminal 10 is not coupled to the predetermined external apparatus, the automatic response setting receiver 183 does not receive the automatic response allowable flag setting by not displaying the setting screen illustrated in FIG. 8.

The automatic response determiner 184 is configured to perform an automatic response determination process to determine whether to automatically responding to a start request for starting transmission of the content data including video data, audio data or the like when the terminal 10 is coupled to the predetermined external apparatus. Note that the automatic response determining process may be performed when the terminal 10 receives the start request, when the terminal 10 starts up, or when the terminal 10 logs into the management system 50.

For example, in the automatic response determining process, the automatic response determiner 184 determines whether the terminal 10 is coupled to the predetermined external apparatus that is controlled by the communications from another apparatus such as the moving apparatus 20 having a moving function via near field communications such as Bluetooth (registered trademark) and a wireless local area network (LAN), or a universal serial bus (USB) or a LAN cable.

The automatic response determiner 184 determines whether the external apparatus corresponds to the predetermined external apparatus based on information acquired from the communicatively connected external apparatus. For example, the automatic response determiner 184 may acquire a type, a name, a model number, identifier information of the external apparatus from the external apparatus or may acquire identifier information that the external apparatus uses in the communications, and determines whether the external apparatus corresponds to the predetermined external apparatus based on the acquired information. The identifier information that the external apparatus uses in the communications may be a MAC address or a service set identifier (SSID) of the external apparatus.

The automatic response determiner 184 determines to execute an automatic response in the automatic response determining process when an automatic response allowable flag is set to be ON by the automatic response setting receiver 183.

The automatic response determiner 184 acquires, from the external apparatus such as the moving apparatus 20, information about a remaining amount of the battery (charge) used by the moving apparatus (e.g., wheel driver 406) in the automatic response determining process. The automatic response determiner 184 determines whether the remaining amount of the battery is a predetermined threshold or more, and subsequently determines to execute the automatic response when the remaining amount of the battery is the predetermined threshold or more. Note that when the remaining amount of the battery is not the predetermined threshold or more, the automatic response determiner 184 will not determine to execute the automatic response.

The automatic response determiner 184 acquires, from the external apparatus such as the moving apparatus 20, information at least about whether a moving mechanism (e.g., the wheel driver 406) is broken in the automatic response determining process. The automatic response determiner 184 subsequently determines whether the external apparatus is broken based on the acquired information. The automatic response determiner 184 determines to execute the automatic response when the external apparatus is not broken. Note that when the external apparatus is broken, the automatic response determiner 184 will not determine to execute the automatic response.

The automatic response determiner 184 determines to execute the automatic response in the automatic response determining process when the automatic response allowable terminal list includes the terminal ID of the request source terminal 10 that has transmitted the start request.

The automatic response determiner 184 determines to execute the automatic response in the automatic response determining process when a time at which the start request is received is included in the time slots managed by the time slot manager 182.

The automatic responder 185 is configured to execute the automatic response to the start request from another terminal 10 (the request source terminal 10) to start transmitting the content data when the automatic response determiner 184 has determined to execute the automatic response.

The following describes a functional configuration of the terminal 10B.

The operation instruction receiver 19a may be implemented by instructions from the CPU 101 illustrated in FIG. 2, and is configured to receive from a different terminal 10 via the transmitter-receiver 11a, operation instruction information to request the terminal 10B to control an apparatus (the external apparatus). The operation instruction information may include the terminal ID of the terminal 10 that has transmitted the operation instruction information, the requested control content, and the like.

The apparatus operation instruction authenticator 19b may be implemented by instructions from the CPU 101 illustrated in FIG. 2, and is configured to authenticate the operation instruction information received by the operation instruction receiver 19a by determining whether the operation instruction information received by the operation instruction receiver 19a is acquired from the terminal 10 having the operation right of the terminal 10B. For example, the apparatus operation instruction authenticator 19b stores in the storage 17 the terminal ID of the terminal 10 having the operation right of the terminal 10B that has been reported from the management system 50. When the operation instruction receiver 19a receives the operation instruction information, the apparatus operation instruction authenticator 19b compares the terminal ID included in the received operation instruction information and the terminal ID of the terminal 10 having the operation right of the terminal 10B stored in the storage 17 and authenticates the operation instruction information received by the operation instruction receiver 19a when the terminal ID included in the received operation instruction information matches the terminal ID of the terminal 10 having the operation right of the terminal 10B.

The apparatus controller 19c may be implemented by instructions from the CPU 101 illustrated in FIG. 2, and is configured to control the moving apparatus 20 based on control information included in the operation instruction information that is received by the operation instruction receiver 19a and authenticated by the apparatus operation instruction authenticator 19b.

The inter-apparatus communications part 19d may be implemented by instructions from the CPU 101 illustrated in FIG. 2, and the external apparatus connection I/F 117 or the near field communications part 118 illustrated in FIG. 2. The following illustration is based upon the assumption that the inter-apparatus communications part 19d performs communications with the moving apparatus 20 via the near field communications part 118.

### Functional Configuration of Moving Apparatus

The moving apparatus 20 serving as an example of the external transmission terminal apparatus may include an inter-apparatus communications part 21 and a travel controller 22.

The inter-apparatus communications part 21 of the moving apparatus 20 may be implemented by instructions from the CPU 401, and the external apparatus I/F 404 or the near field communications part 405 illustrated in FIG. 4. Note that it is assumed that the inter-apparatus communications part 21 performs communications with the terminal 10B using the near field communications part 405 in the first embodiment.

The travel controller 22 of the moving apparatus 20 may be implemented by instructions from the CPU 401 illustrated in FIG. 4. The travel controller 22 may control the wheel driver 406 and the steering part 407 illustrated in FIG. 4 so as to control movement (traveling) of the moving apparatus 20 such as moving forward, moving backward, clockwise turning, and counter-clockwise turning.

### Functional Configuration of Management System

The management system 50 includes a transmitter-receiver 51, a terminal authenticator 52, a terminal manager 53, a destination list manager 54, a ion manager 55, an apparatus operation right manager 56, and a storing-reading processor 57. The above-described components are functions or functional units implemented by causing any one of the components illustrated in FIG. 3 to operate on instructions from the CPU 201 in accordance with the management system-specified programs loaded from the HD 204 in the RAM 20. Further, the management system 50 further includes a storage 5000 implemented by the HD 204 or the like illustrated in FIG. 3.

### Detailed Functional Configuration of Management System

The following describes a detailed functional configuration of the management system 50. Note that it the following, an illustration is also given of a relationship with main components illustrated in FIG. 3 for implementing the respective functions of the management system 50.

The transmitter-receiver 51 of the management system 50 is implemented by instructions from the CPU 201 illustrated in FIG. 3 and the network I/F 209 illustrated in FIG. 3. The transmitter-receiver 51 is configured to transmit to or receive from other terminals, apparatuses, or systems via the communications network 2 various types of data (or information).

The terminal authenticator 52 of the management system 50 is implemented by instructions from the CPU 201 illustrated in FIG. 3. For example, the terminal authenticator 52 authenticates the terminal 10 by determining whether an authentication management database (DE) 5002 includes a combination of a terminal ID and a password included in login request information received via the transmitter-receiver 51.

The terminal manager 53 of the management system 50 is implemented by instructions from the CPU 201 illustrated in FIG. 3 and is configured to manage a destination name, an operating status, received date and time of request information or the like, and the IP address or the like of the request source terminal stored in the terminal management DB 5003 in association with the terminal IDs. When the user switches the power of the terminal 10 from ON to OFF, the terminal 10 transmits status information indicating that the power is turned OFF. The terminal manager 53 changes an operating status indicating ONLINE of the terminal management DB 5003 to OFFLINE based on the status information indicating the power to be switched OFF transmitted from the terminal 10. Note that an illustration will be given later of the terminal management DE 5003.

The terminal manager 53 searches a destination list management DE 5004 by the terminal ID of the request source terminal that has transmitted a login request as a search key to extract the terminal ID of the destination terminal capable of having communication with the request source terminal. The terminal manager 53 searches the destination list management DE 5004 by the terminal ID of the request source terminal that has transmitted the login request as a search key to extract terminal IDs of other request source terminals that have registered the terminal ID of the request source terminal as a destination terminal candidate.

The terminal manager 53 further searches the terminal management DB 5003 by the terminal ID of the extracted destination terminal candidate as a search key to read the operating status of each of the extracted terminal IDs. As a result, the terminal manager 53 may be able to acquire the operating statuses of the destination terminal candidates capable of having communications with the request source terminal that has transmitted a login request. The terminal manager 53 may also be able to search the terminal management DB 5003 by the extracted terminal IDs as search keys to acquire the operating status of the request source terminal that has transmitted the login request

The destination list manager 54 is implemented by instructions from the CPU 201 illustrated in FIG. 3, and is configured to add or delete the terminal ID of the destination terminal for each of the terminal IDs of the request source terminals in the destination list management DE 5004. Note that an illustration is given later of the destination list management DE 5004.

The session manager 55 is implemented by instructions from the CPU 201 illustrated in FIG. 3, and is configured to control sessions managed by the management system 50. Examples of the control of the sessions may include control of establishing sessions, control of allowing the terminals 10 to participate in the established sessions, control of disconnecting the sessions, generation of session IDs, and the like. The session manager 55 manages the request source terminal ID of the request source terminal 10 that has started a session, the destination terminal ID of the destination terminal 10, and the like stored in association with the session ID serving as session identification information in the session management DB 5005. Note that an illustration will be given later of the session management DB 5005.

The apparatus operation right manager 56 is implemented by instructions from the CPU 201 illustrated in FIG. 3, and may be configured to manage an operation right to perform operation of the terminal 10 (hereinafter also called “apparatus control terminal”) configured to control an apparatus such as the moving apparatus 20. For example, the apparatus operation right manager 56 may change a setting of the terminal 10 serving as the apparatus control terminal capable of operating the moving apparatus 20 from the terminal 10A to the terminal 10B. The apparatus control terminal 10 is capable of operating an apparatus such as the moving apparatus 20 via the communications between the moving apparatus 20 and the apparatus control terminal 10.

The apparatus operation right manager 56 may also manage a transfer right to transfer the operation right of the apparatus control terminal 10 to another terminal 10.

The apparatus operation right manager 56 may also manage information (e.g., the terminal ID) about “apparatus operation responsible terminal” that is a terminal 10 of a person who is responsible for predetermined apparatus operations, such as a user who manages the apparatus control terminal, a user accustomed to operating the apparatus control terminal, and the like.

The storing-reading processor 57 is implemented by instructions from the CPU 201 or HDD 205 illustrated in FIG. 3. The storing-reading processor 57 is configured to store various types of data into the storage 5000 and read various types of data from the storage 5000.

### Relay Apparatus

The relay apparatus 30 is configured to relay communications of the content data between multiple terminals 10 that participate in the same session based on the session ID serving as identifier information of a session. Note that the functional configuration of the relay apparatus 30 is similar to the functions of the related art relay apparatus 30, and hence, a detailed description of the functional configuration of the relay apparatus 30 is omitted from the specification. Note that the functions of the relay apparatus 30 may be implemented by instructions from the CPU 201 illustrated in FIG. 3

### Examples of Information Managed by Management System 50

The following illustrates each of the management DBs stored in the storage 5000 of the management system 50.

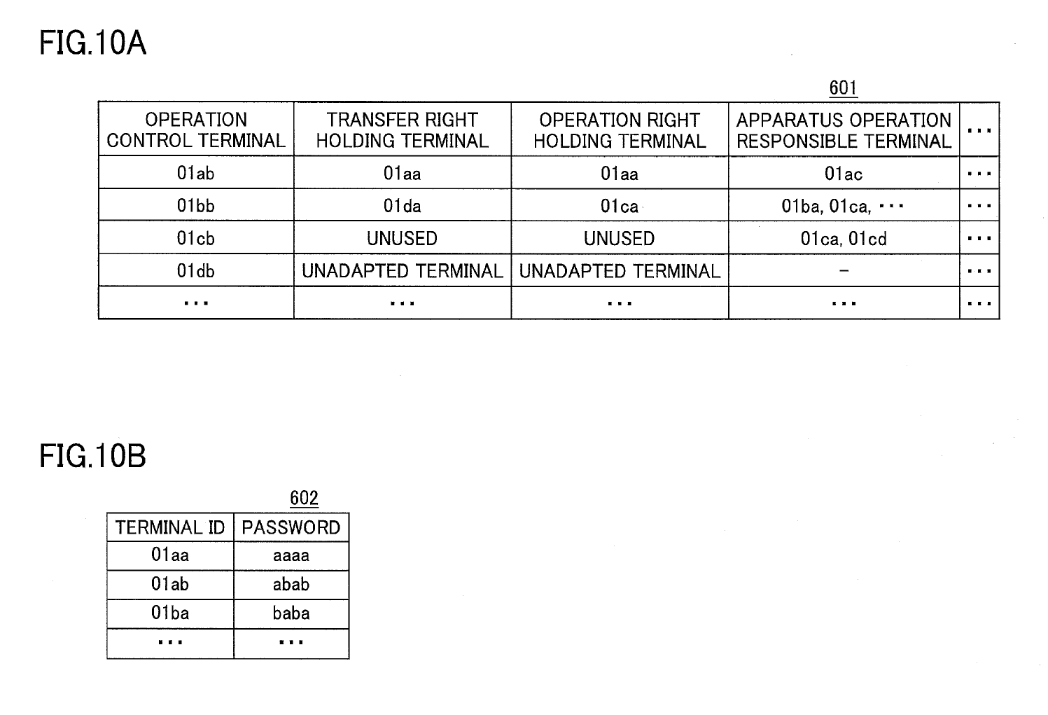

FIGS. 9 to 11 are diagrams illustrating examples of information managed by the management system 50.

### Automatic Response List Management Table

The automatic response list management DB 5006 stored in the storage 5000 of the management system 50 may include an automatic response list management table 801 illustrated in FIG. 9, for example. The automatic response list management table 801 may be configured to manage the terminal IDs of the destination terminals that receive a start request to start the communications in a TV conference in association with the terminal IDs (automatic response allowable terminal IDs) of the request source terminals that are allowed to perform an automatic response to the terminal IDs of the destination terminals. In the example illustrated in FIG. 9, the destination terminal having the terminal ID “01ab” may be allowed to perform an automatic response to the start requests from the terminals having the terminal IDs “01aa”, “01ca”, and “01cb”.

### Apparatus Operation Right Management Table

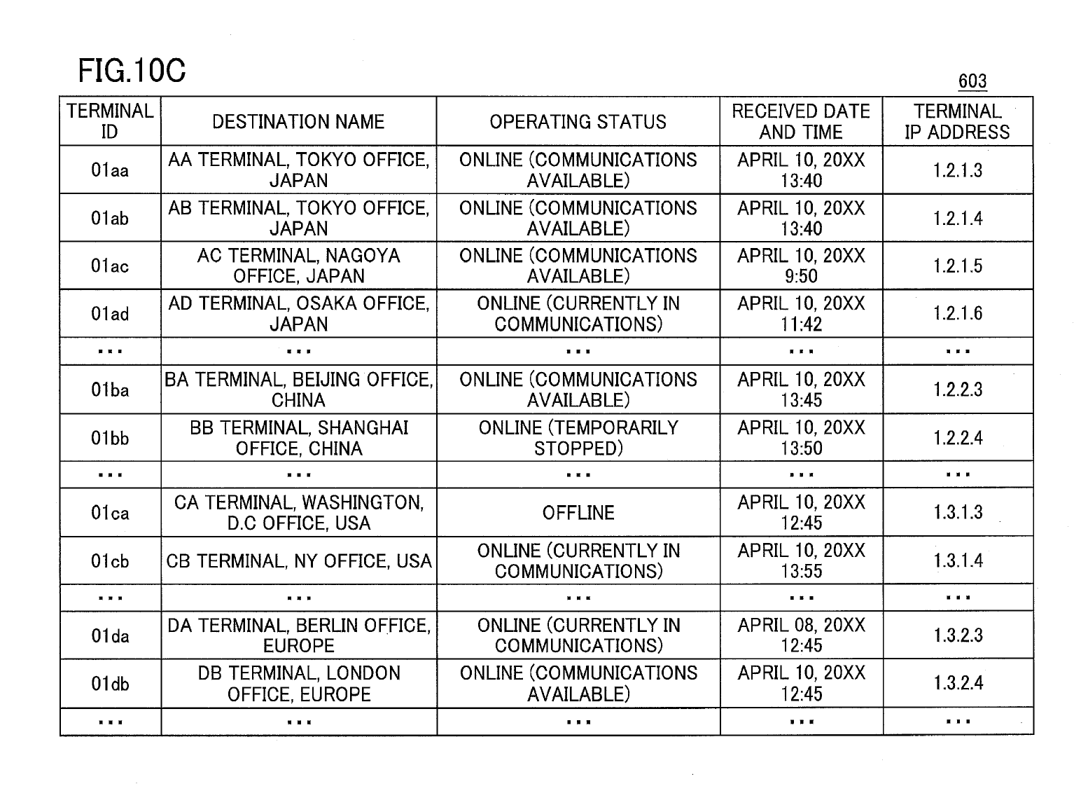

The apparatus operation right management DB 5001 stored in the storage 5000 of the management system 50 may include an apparatus operation right management table 601 illustrated in FIG. 10A, for example. The apparatus operation right management table 501 may be configured to manage information including a “transfer right holding terminal”, an “operation right holding terminal”, and an “apparatus operation responsible terminal” in association with the terminal IDs of the operation control terminals configured to control an apparatus such as the moving apparatus 20.

The information on the transfer right holding terminal may be information (e.g., the terminal ID) for identifying the terminal 10 having a right to transfer the apparatus operation right (hereinafter called a “transfer right”). Note that the apparatus operation right indicates a right to operate the apparatus control terminal. The apparatus operation right manager 56 may be configured to manage the terminal ID of the terminal 10 that has first established a session with the apparatus control terminal as the transfer right holding terminal. The apparatus operation right manager 56 may also manage the terminals 10 having the apparatus operation right returned from the terminals 10 to which the apparatus operation right has been transferred as the operation right holding terminals.

The information on the “operation right holding terminal” may be information (e.g., the terminal ID) for identifying the terminal 10 having the apparatus operation right. Note that the apparatus operation right indicates a right to operate an apparatus control terminal. The apparatus operation right manager 56 may be configured to manage the terminal ID of the terminal 10 that currently holds the apparatus operation right as the operation right holding terminal.

The information on the “apparatus operation responsible terminal” may be information (e.g., the terminal ID) for identifying the terminal 10 used by a person who is responsible for the predetermined apparatus operations including a user who manages the apparatus control terminal or a user who is accustomed to operating the apparatus control terminal. The information on the apparatus operation responsible terminal includes the terminal ID of the terminal of the predetermined responsible user for each of the apparatus control terminals.

Note that the “unused” in the information included in the apparatus operation right management table 601 indicates that the apparatus control terminal is not currently used (i.e., does not currently participate in the session). In addition, the “unadapted terminal” in the information included in the apparatus operation right management table 601 indicates the terminal is not the apparatus control terminal.

### Authentication Management Table

The authentication management DB 5002 stored in the storage 5000 of the management system 50 may include an authentication management table 602 illustrated in FIG. 10B, for example. The authentication management table 602 may be configured to manage the terminal IDs of the terminals 10 managed by the management system 50 in association with respective passwords corresponding to the terminal IDs. For example, in the authentication management table 602 illustrated in FIG. 10, a password for the terminal ID “01aa” of the terminal 10 is “aaaa”.

### Terminal Management Table

The terminal management DB 5003 stored in the storage 5000 of the management system 50 may include a terminal management table 603 illustrated in FIG. 10C, for example. The terminal management table 603 may be configured to manage destination names of the terminals 10 serving as destinations, operating statuses of the respective terminals 10, received times and dates of the later-described login request information received by the transmission management system 50, and IP addresses of the terminals 10 in association with respective terminal IDs of the terminals 10. For example, in accordance with the terminal management table 603 illustrated in FIG. 10C, the terminal 10 having the terminal ID “01aa” is “AA terminal, TOKYO Office, JAPAN”, and the operating status of this terminal 10 is “ONLINE (communications available)”. Likewise, the terminal 10 having the terminal ID “01aa” has received date and time “April 10, 20xx 13:40” at which login request information transmitted from this terminal 10 is received by the management system 50 and has an IP address “1.2.1.3”.

### Destination List Management Table

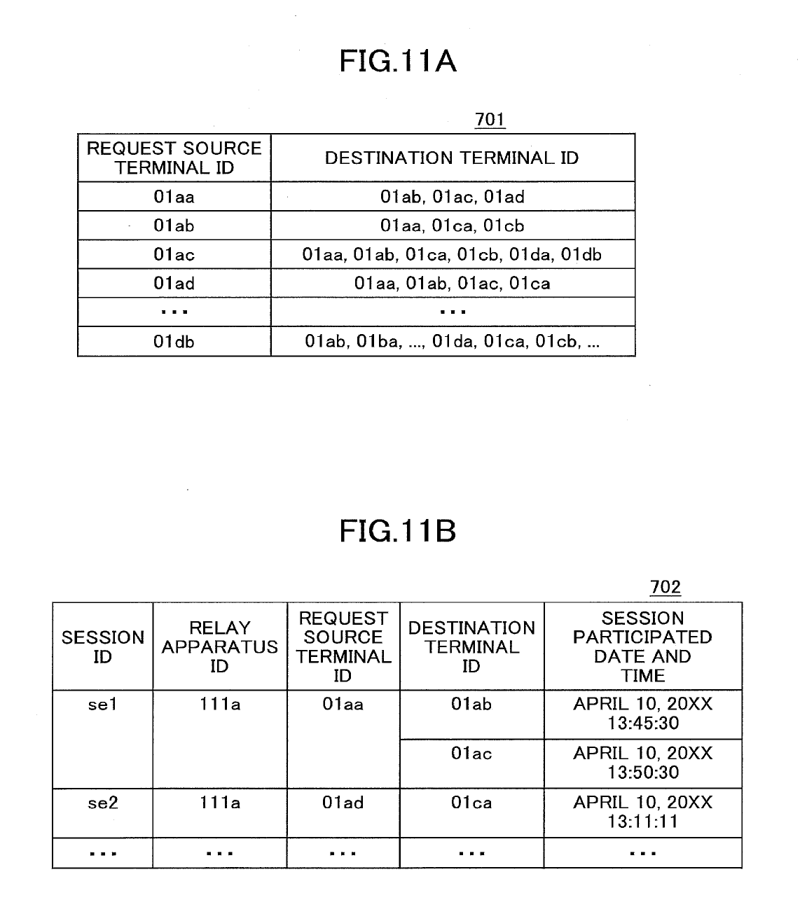

The destination list management DB 5004 stored in the storage 5000 of the management system 50 includes a destination list management table 701 illustrated in FIG. 11A. The destination list management table 701 is configured to manage all the terminal IDs of the destination terminals registered as destination terminal candidates in association with the terminal ID of the request source terminal that has transmitted a communications start request in the TV conference. For example, in accordance with the destination list management table 701 illustrated in FIG. 11A, the destination terminal candidates that are capable of receiving the communications start request from the request source terminal having the terminal ID “01ab” are terminals having the terminal IDs “01aa”, “01ca”, and “01cb”. The destination terminal candidates may be updated by the destination list manager 54 adding or deleting the destination terminals as candidates when any one of the request source terminals transmits an adding request or a deleting request to the management system 50.

### Session Management Table

The session management DB 5005 stored in the storage 5000 of the management system 50 includes a session management table 702 illustrated in FIG. 11B. The session management table 702 is configured to manage information including a relay apparatus ID of the relay apparatus 30 for use in communications relaying, the terminal ID of the request source terminal, the terminal IDs of the destination terminals, and session start dates and times in association with each of the session IDs that are session identifier information. For example, in accordance with the session management table 702 illustrated in FIG. 11E, a session having the session ID “se2” is conducted between the request source terminal having the terminal ID “01ad” and the destination terminal having the terminal ID “01ca”. In addition, in accordance with the session management table 702, the session having the session ID “se2” has started at “13:11:11” on “April 10, 20xx”.

### Process

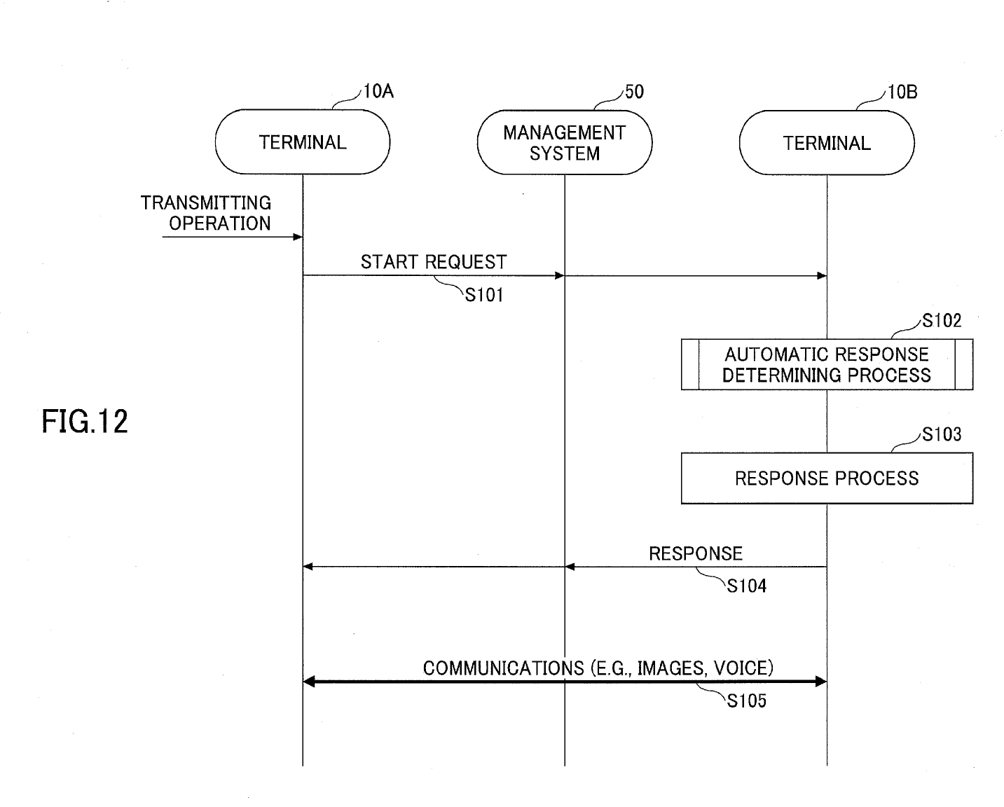

The following illustrates an outline of operations of the communications system 1 to transmit an automatic response to the communications start request with reference to FIG. 12. FIG. 12 is a sequence diagram of the communications system that transmits an automatic response. The following example is based on the assumption in which the terminal 10A transmits a session start request to the terminal 10B.

The communications (TV conference) request source terminal 10A transmits a start request to the destination terminal 10B via a not-illustrated management system 50 based on a transmitting operation of the user (step S101).

The destination terminal 10B performs the later-described automatic response determining process to determine whether to transmit an automatic response based on whether the destination terminal 10B is coupled to the external apparatus or the like (step S102). When the destination terminal 10B determines to execute an automatic response, the destination terminal 10B performs a response process (step S103) of executing the automatic response. When the destination terminal 10B does not determine to execute an automatic response, the destination terminal 10B performs the response process (step S103) in accordance with the user's response operation. The destination terminal 10B then transmits the response of step S103 to the request source terminal 10A (step S104) via the not-illustrated management system 50. The communications between the request source terminal 10A and the destination terminal 10B then start via the relay apparatus 30 (step S105).

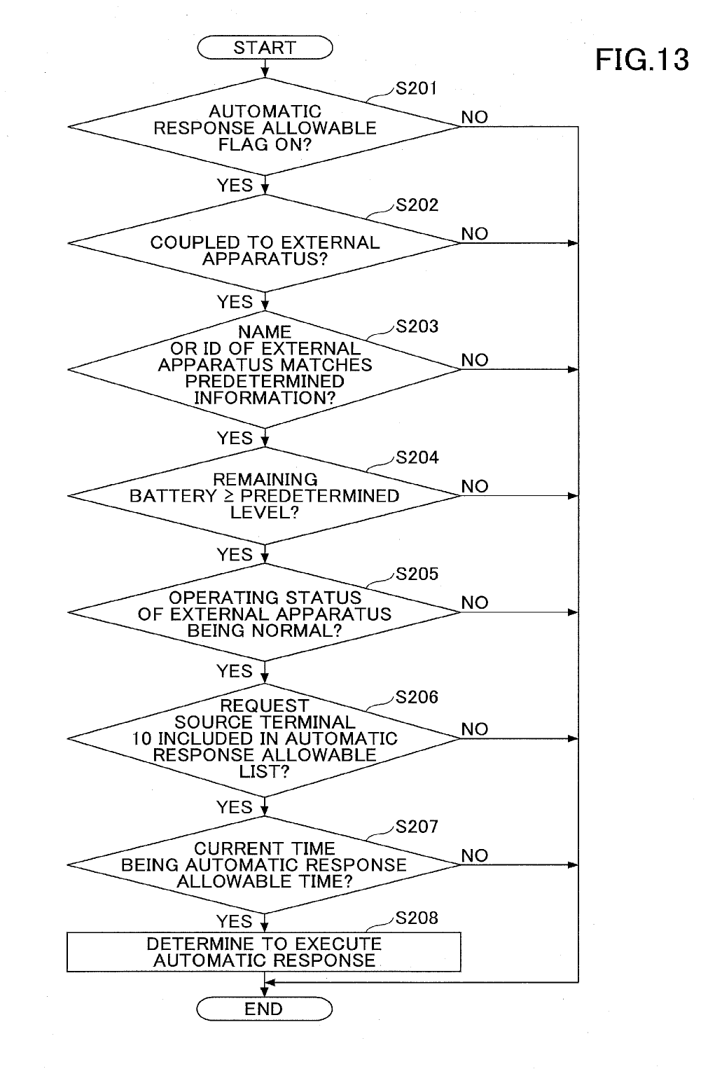

Next, a detailed illustration of an example of the automatic response determining process of step S102 performed by the automatic response determiner 184 in FIG. 12 is given with reference to FIG. 13. FIG. 13 is a flowchart illustrating the automatic response determining process.

The automatic response determiner 184 determines whether the automatic response allowable flag is ON (step S201). When the automatic response allowable flag is not ON (NO in step S201), the automatic response determiner 184 ends the process.

When the automatic response allowable flag is ON (YES in step S201), the automatic response determiner 184 determines that the destination terminal 10B is coupled to the external apparatus (step S202). When the destination terminal 10B is not coupled to the external apparatus (NO in step S202), the automatic response determiner 184 determines to end the process.

When the destination terminal 10B is coupled to the external apparatus (YES in step S202), the automatic response determiner 184 determines that the information acquired from the external apparatus matches the predetermined information (step S203). When the information acquired from the external apparatus does not match the predetermined information (NO in step S203), the automatic response determiner 184 determines to end the process.

When the information acquired from the external apparatus matches the predetermined information (YES in step S203), the automatic response determiner 184 determines whether the remaining amount of the battery is a predetermined level (a predetermined value) or more (step S204). When the remaining amount of the battery is not the predetermined level (the predetermined value) or more (NO in step 204), the automatic response determiner 184 ends the process.

When the remaining amount of the battery is the predetermined level (the predetermined value) or more (YES in step 204), the automatic response determiner 184 determines whether the operating status of the external apparatus is normal (step S205). When the operating status of the external apparatus is not normal (NO in step 205), the automatic response determiner 184 ends the process.

When the operating status of the external apparatus is normal (YES in step 205), the automatic response determiner 184 determines whether the request source terminal 10A is included in the automatic response allowable list (step S206). When the request source terminal 10A is not included in the automatic response allowable list (NO in step 206), the automatic response determiner 184 ends the process.

When the request source terminal 10A is included in the automatic response allowable list (YES in step 206), the automatic response determiner 184 determines whether a current time is automatic response allowable time (step S207). When the current time is not the automatic response allowable time (NO in step 207), the automatic response determiner 184 ends the process.

When the current time is the automatic response allowable time (YES in step 207), the automatic response determiner 184 determines to execute the automatic response (step S208) and then ends the process.

Note that the automatic response determining process performed by the automatic response determiner 184 has determined to execute the automatic response automatic response in step S208 of FIG. 13, the automatic responder 185 executes the automatic response in response to the start request received from another terminal 10 to start transmitting the content data. When the automatic response determining process performed by the automatic response determiner 184 has not determined to execute the automatic response automatic response, the terminal 10 may inform the user of an incoming call, for example. When the user subsequently presses the response button or the like, the automatic responder 185 transmits a response to the start request.

### Process Flow

The following illustrates an example of a detailed process flow of the communications system 1.

### Preparatory Process

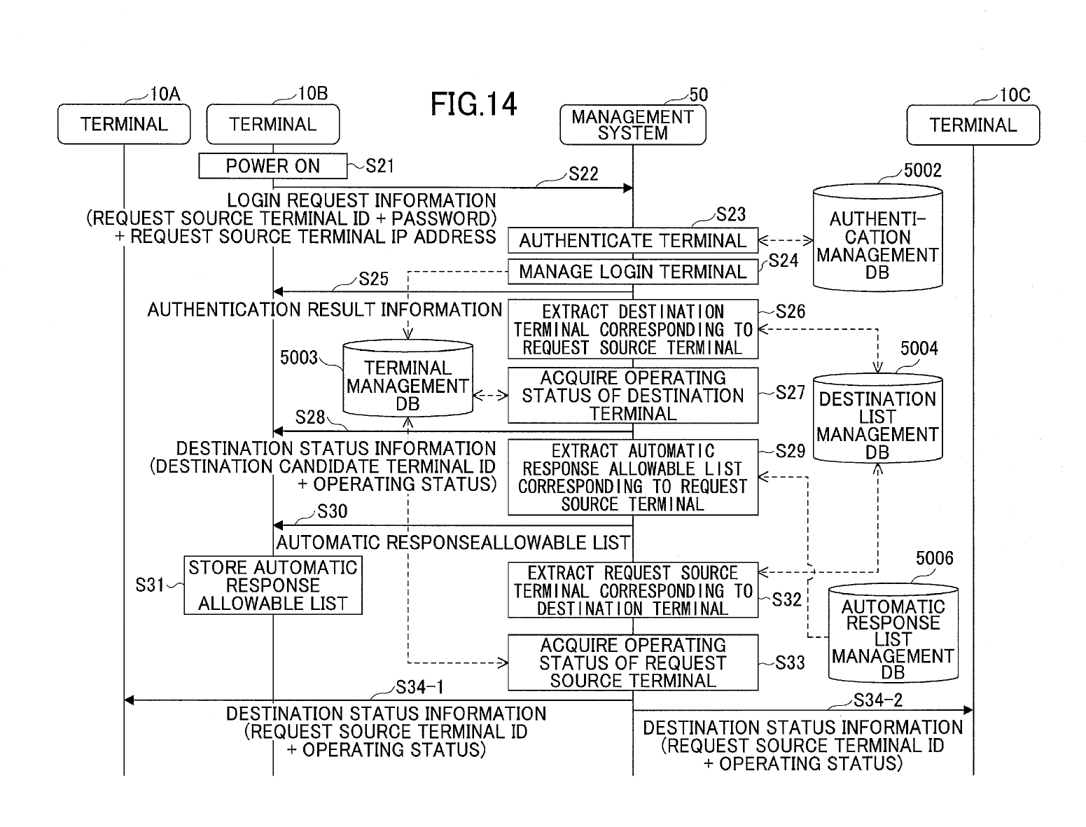

FIG. 14 is a sequence diagram illustrating an example of a preparatory process of the communications system 1 according to the embodiment. The following illustrates an example of the preparatory process before the session between the terminals 10A, 10B, and 10C starts. Note that in the following, it is assumed that the terminal ID of the terminal 10A is “01aa”, the terminal ID of the terminal 1B is “01ab”, and the terminal ID of the terminal 10C is “01ac”. In FIG. 14, it is assumed that various types of management information are transmitted or received via management information-specific sessions.

Initially, when the user of the request source terminal 10B performs an operation to switch the power of the terminal 10B ON, the operation input receiver 12 illustrated in FIG. 5 receives the user's power ON operation to switch the power of the terminal 10B ON (step S21). Then, the communications controller 13 transmits login request information to request login from the transmitter-receiver 11 to the management system 50 via the communications network 2 using the above-described power ON as trigger (step S22). Note that the login request information being transmitted by the power ON operation of the terminal 10B may merely be an example. The login request information may be transmitted by the user's operation of the input part 108 or may be transmitted by the activation of the application.

The login request information includes the terminal ID (request source terminal ID) and a password for identifying the own terminal 10B as a request source. These terminal ID and password may be information read from the storage 17. When the login request information is transmitted from the terminal 10B to the management system 50, the management system 50 serving as a receiver may be able to detect the IP address of the terminal 10B serving as a transmitter.

The terminal authenticator 52 of the management system 50 subsequently searches the authentication management table 602 by the terminal ID and password combination as a search key included in the login request information received via the transmitter-receiver 51. The terminal authenticator 52 performs authentication based on whether the authentication management table 602 includes the terminal ID and password combination included in the login request information received from the terminal 10B (step S23).

When the terminal authenticator 52 determines that the received login request is a login request from the terminal 10B having a valid access right, the terminal manager 53 changes the operating status of the terminal 10B having the terminal ID “01ab” recorded in the terminal management table 603 to “ONLINE (communications available)”. The terminal manager 53 updates received date and time, and optionally updates the IP address of the terminal 10B (step S24). The terminal management table 603 manages the operating status “ONLINE (communications available)”, the received date and time “April 10, 20xx 13:40”, and the IP address “1.2.1.4” of the terminal 10E in association of the terminal ID “01ab” of the terminal 10B as a result.

The transmitter-receiver 51 of the management system 50 then transmits authentication result information indicating an authentication result obtained by the terminal authenticator 52 via the communications network 2 to the login request terminal 10E that has transmitted the login request (step S25). The following illustrates an example where the terminal authenticator 52 has determined that the terminal 10B has a valid access right.

The terminal manager 53 of the management system 50 searches the destination list management table 701 by the terminal ID “01ab” of the request source terminal (the terminal 10E) as a search key. The terminal manager 53 extracts the terminal IDs of the destination terminal candidates capable of communicating with the request source terminal (the terminal 10E) (step S26). In this example, “01aa”, “01ca”, and “01cb” are extracted as the terminal IDs of the destination terminals corresponding to the terminal ID “01ab” of the request source terminal (the terminal 10E).

Next, the terminal manager 53 searches the terminal management table 603 by the terminal IDs (i.e., “01aa”, “01ca”, and “01cb”) of the extracted destination terminal candidates as search keys. Hence, the terminal manager 53 acquires the operating statuses of the destination terminal candidates having the extracted terminal IDs (i.e., “01aa”, “01ca”, and “01cb”) by reading each of the extracted terminal IDs (step S27).

The transmitter-receiver 51 subsequently transmits to the request source terminal (the terminal 10B) destination status information including the respective operating statuses of the destination terminal candidates having the terminal IDs (“01aa”, “01ca”, and “01cb”) (step S28). Accordingly, the request source terminal (the terminal 10B) may be able to detect the current operating statuses of the destination terminal candidates having the terminal IDs (“01aa”, “01ca”, and “01cb”).

The terminal manager 53 of the management system 50 searches the automatic response list management table 801 by the terminal ID “01ab” of the request source terminal (the terminal 10B) as a search key. The terminal manager 53 extracts the terminal IDs of the terminals (the automatic response allowable list) to which the request source terminal (the terminal 10B) is allowed to transmit the automatic response (step S29). In this example, it is assumed that “01aa”, “01ca”, and “01cb” are extracted as the terminal IDs of the terminals on the automatic response allowable list corresponding to the terminal ID “01ab” of the request source terminal (the terminal 10B).

The transmitter-receiver 51 subsequently transmits the automatic response allowable list to the request source terminal (the terminal 10B) (step S30).

The request source manager 181 of the request source terminal (the terminal 10B) stores the received automatic response allowable list (step S31).

The terminal manager 53 of the management system 50 searches the destination list management table 701 by the terminal ID “01aa” of the request source terminal (the terminal 10A) that has transmitted the login request as a search key. The terminal manager 53 extracts terminal IDs of the other request source terminals that register the terminal ID “01aa” of the request source terminal (the terminal 10A) as the destination terminal candidates (step S32). According to the destination list management table 701 illustrated in FIG. 11A, the terminal IDs of other extracted request source terminals are “01ab”, “01ac”, and “01ad”.

The terminal manager 53 of the management system 50 searches the terminal management table 603 by the terminal ID “01aa” of the request source terminal (the terminal 10A) that has transmitted the login request as a search key. The terminal manager 53 thus acquires the operating status of the request source terminal (the terminal 10A) that has transmitted the login request (step S33).

The transmitter-receiver 51 subsequently extracts, among the terminal IDs (“01ab”, “01ac”, and “01ad”) extracted in step S29, the terminal IDS (“01ab” and “01ac”) having the operating status “ONLINE (communications available)” in the terminal management table 603. The transmitter-receiver 51 transmits destination status information including the terminal ID “01aa” and the operating status “ONLINE (communications available)” of the request source terminal (the terminal 10A) to the terminals Destination terminals 10B and 10C corresponding to the extracted terminal IDs (“01ab” and “01ac”) (step S34-1 and S34-2).

Note that when the transmitter-receiver 51 transmits the destination status information to the terminals 10B and 10C, the transmitter-receiver 51 refers to IP addresses of the terminals managed in the terminal management table 603 based on the respective terminal IDs (“01ab” and “01ac”). The terminal ID “01aa” and the operating status “ONLINE” of the request source terminal (the terminal 10A) may be transmitted to each of the destination terminals (terminals Destination terminal 10B and 10C) capable of having communications with the request source terminal (the terminal 10A) that has transmitted the login request as a destination terminal.

On the other hand, processes similar to steps S22 to step S31-1 or step S31-2 may be conducted in the other terminals 10 in accordance with the user's power ON operation.

### Communications Process

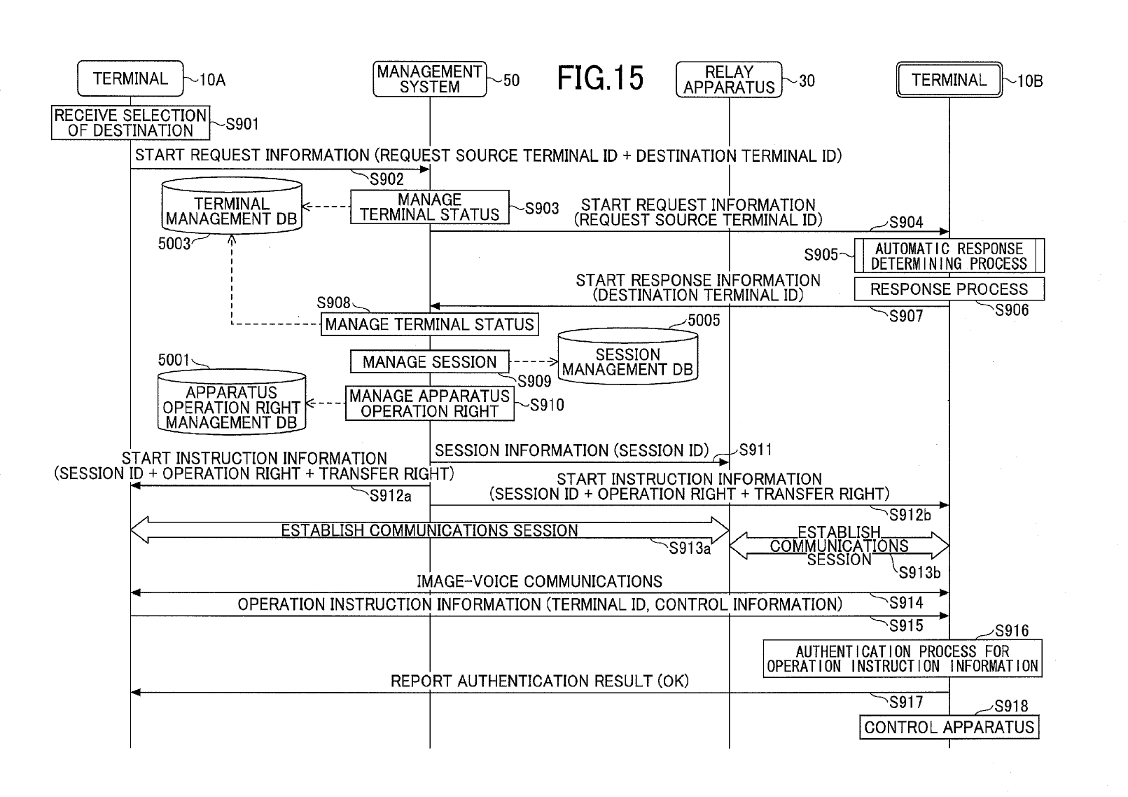

FIG. 15 is a sequence diagram illustrating a detailed example of a communications process of the communications system 1. The following illustrates an example of communication management method for starting communications between the terminal 10A and the terminal 10B that serves as an apparatus control terminal capable of controlling the moving apparatus 20.

In step S901, when the terminal 10A receives the selection of the destination terminal (the terminal 10B) operated by the user of the terminal 10A, the terminal 10A transmits start request information to request the management system 50 to start a session (step S902). The start request information may, for example, include the request source terminal ID of the request source terminal 10A and the terminal ID of the destination terminal 10B. The start request information may further include information about the IP address of the request source terminal 10A.

In step S903, the terminal manager 53 of the management system 50 that has received the start request information from the terminal 10A updates the terminal management DB 5003 based on the terminal ID “01aa” of the request source terminal (the terminal 10A) included in the start request information example, the terminal manager 53 may change information about the operating status corresponding to the terminal ID “01aa” of the terminal 10A into “ONLINE (currently in communications)” and updates the received date and time

In step S904, the session manager 55 of the management system 50 transmits the start request information to request the destination terminal 10B to start the session. The start request information may, for example, include the request source terminal ID of the request source terminal 10A.

In step S905, the terminal 10B executes the automatic response determining process illustrated in FIG. 13.

In step S906, when the terminal 10B determines to transmit an automatic response, the terminal 10B executes an automatic response process whereas when the terminal 10B does not determine to transmit an automatic response, the terminal 10B executes a response process in accordance with the user's response operation.

In step S907, the terminal 10B that has received the start request information from the management system 50 transmits start response information to the management system 50. This start response information may include the destination terminal ID of the terminal 10B.

In step S908, the terminal manager 53 of the management system 50 that has received the start response information from the terminal 10B updates the terminal management DE 5003 based on the terminal ID “01ab” of the request source terminal 10B included in the start response information. For example, the terminal manager 53 may change information about the operating status corresponding to the terminal ID “01ab” of the terminal 10B into “ONLINE (currently in communications)” and updates the received date and time.

In step S909, the session manager 55 of the management system 50 generates a session ID as identifier information for identifying a session. The session manager 55 further stores the generated session ID in association with the request source terminal ID (i.e., the terminal ID of the terminal 10A) and the destination terminal ID (i.e., the terminal ID of the terminal 10B) in the session management DB 5009.

In step S910, the apparatus operation right manager 56 of the management system 50 stores the request source terminal (the terminal 10A) in the apparatus operation right, management DB 5001 as a terminal 10 having the operation right and transfer right of the terminal 10B that serves as the apparatus control terminal. For example, the apparatus operation right manager 56 stores the terminal ID “01aa” of the terminal 10A in respective columns of the “transfer right holding terminal” and the “operation right holding terminal” corresponding to the apparatus control terminal “01ab”in the apparatus operation right management table 601 illustrated in FIG. 10A.

In step S911, the session manager 55 of the management system 50 transmits session information to the relay apparatus 30. This session information may, for example, include information about the session ID generated in step S909.

In step S912a, the session manager 55 of the management system 50 transmits the start instruction information to instruct the terminal 10A to start the session. In step S912b, the session manager 55 of the management system 50 transmits the start instruction information to instruct the terminal 10B to start the session.

The above-described start instruction information may include information about the session ID, the transfer right and the operation right of the terminal 10B. The information about the session ID, the transfer right and the operation right of the terminal 10B may correspond to information indicating the “transfer right holding terminal” and the “operation right holding terminal” of the apparatus operation right management table 601 illustrated in FIG. 10A, for example.

The management system SO, the terminal 10A, and the terminal 10B may thus have information about the operation right and the transfer right of the terminal 10B.

Note that the above information held by the management system 50, the terminal 10A, and the terminal 10B may optionally include information corresponding to an “apparatus operation responsible terminal” in the apparatus operation right management table 601 illustrated in FIG. 10A.

In step S913a, the terminal 10A establishes a communications session between the terminal 10A and the relay apparatus 30 based on the received start instruction information. Similarly, in step S913b, the terminal 10B establishes a communications session between the terminal 10B and the relay apparatus 30 based on the received start instruction information.

In step S914, the terminal 10A and the terminal 10B participate in the communications session having the same session ID to mutually communicate (transmit or receive) the content data such as image data or audio data with each other to conduct a TV conference, for example. The terminal 10A may transmit to or receive from the terminal 10B information relating to the operations of an apparatus (e.g., the moving apparatus 20) using the established communications session.

Note that the information relating the apparatus operations may be transmitted or received between the terminal 10A and the terminal 10B using a control session via the management system 50 without using the communications session, or may be transmitted or received between the terminal 10A and the terminal 10B via a communications network 2 or the like.

In this example, it is assumed that the terminal 10A transmits to or receives from the terminal 10B the information relating to the operations of an apparatus (e.g., the moving apparatus 20) using the established communications session.

In step S915, when the user of the terminal 10A inputs an operation screen of an apparatus, the terminal 10A transmits operation instruction information in accordance with the operation by the user of the terminal 10A using the communications session. The operation instruction information may include the terminal ID of the terminal 10A and control information in accordance with operation content of the user.

In step S916, when the operation instruction receiver 19a of the terminal 10B receives the operation instruction information transmitted from the terminal 10A, the apparatus operation instruction authenticator 19b executes an authentication process on the received operation instruction information. For example, when the apparatus operation instruction authenticator 19b compares the terminal ID included in the operation instruction information and the terminal ID of the terminal having the operation right of the terminal 10B reported from the management system 50 and finds that these two IDs match, the apparatus operation instruction authenticator 19b authenticates the operation instruction information. The apparatus operation instruction authenticator 19b also reports the authenticated operation instruction information to the apparatus controller 19c.

In step S917, the apparatus operation instruction authenticator 19b of the terminal 10B reports the authenticated result to the terminal 10A. In this example, it is assumed that the authenticated result in step S914 is OK (successful).

In step S918, the apparatus controller 19c of the terminal 10B controls the apparatus (the moving apparatus 20) via the inter-apparatus communications part 19d based on the control information included in the reported operation instruction information.

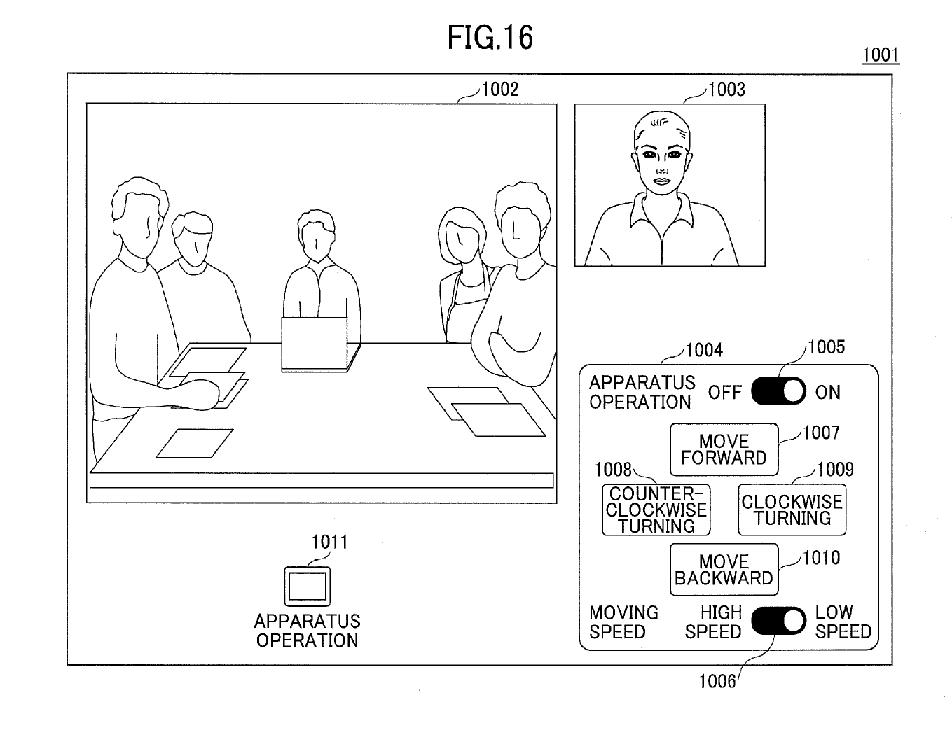

FIG. 16 is a diagram illustrating an example of a display screen of a terminal. The display screen 1001 of the apparatus operation terminal 10A may, for example, include an image 1002 imaged by the imager 14 of the terminal 10B, an image 1003 imaged by the imager 14 of the terminal 10A, and an apparatus operation screen 1004.

The user of the terminal 10A may thus be able to conduct a TV conference with the user of the terminal 10B while viewing the images 1002 and 1003. The user of the terminal 10A may perform remote operations of the moving apparatus 20 via the terminal 10B using the apparatus operation screen 1004.

In the example of FIG. 16, the apparatus operation screen 1004 displays a switch 1005 to switch the apparatus operation to be ON or OFF, and a switch 1006 to switch a moving speed of the moving apparatus 20.

The user of the terminal 10A may be able to select whether to operate the moving apparatus 20 using the switch 1005 to switch the apparatus operation to be ON or OFF. As an example, the apparatus operation screen 1004 may be displayed by the user's selection of an apparatus operation icon 1011 or may be hidden by switching the switch 1005 to be OFF.

The user of the terminal 10A may be able to switch the moving speed to high speed or low speed using the switch 1006 to the moving speed of the moving apparatus 20.

The apparatus operation screen 1004 also displays a move forward button 1007, a move backward button 1010, a clockwise turning button 1009, and a counter-clockwise turning button 1008.

The user of the terminal 10A may be able to select a corresponding one of the above buttons to move the moving apparatus 20 forward or backward, or turn the moving apparatus 20 clockwise or counter-clockwise.

For example, the user of the terminal 10A may perform remote operations of the terminal 10B and the moving apparatus 20 based on the image 1002 imaged by the imager 14 of the terminal 10B even though the user of the terminal 10A is unable to directly view the terminal 10B and the moving apparatus 20 with the user's eyes.

The communications system 1 according to the first embodiment capable of implementing a multi-locational conference may be able to execute an automatic response even when there are no people around a telepresence robot having the moving apparatus 20 and the terminal 10B.

### Other Embodiments

The above-described embodiment has demonstrated an example in which the apparatus control terminal (the terminal 10B) is coupled to the moving apparatus 20. However, the demonstrated example may merely be a preferable example, and a predetermined apparatus (external apparatus) to which the apparatus control terminal (the terminal 10B) may have no moving function.

For example, the terminal 10B may execute an automatic response when the terminal 10B is coupled to a predetermined machining apparatus or a personal computer in a plant or an office.

According to the disclosed embodiments, there is provided a transmission terminal for use in transmission of content data in response to a start request for starting the transmission of the content data from an external terminal. The transmission terminal includes a memory and one or more processors programmed to execute a process including determining whether the transmission terminal is coupled to a predetermined external apparatus; and transmitting a response to the start request, when the transmission terminal is determined to be coupled to the predetermined external apparatus.

The disclosed technology enables simply responding to a start request for starting to transmit the content data

Note that the system configuration disclosed in the above embodiments is merely an example, and the disclosed system configuration may be vary depending on the purpose or the intended use.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

The present invention is not limited to the specifically disclosed embodiments, and variations and modifications may be made without departing from the scope of the present invention.

What is claimed is:

1. A transmission terminal for use in transmission of content data in response to a start request for starting the transmission of the content data from an external terminal, the transmission terminal comprising:
a memory; and
one or more processors programmed to execute a process; the process including
determining whether the transmission terminal is coupled to a predetermined external apparatus; and
transmitting a response to the start request, when the transmission terminal is determined to be coupled to the predetermined external apparatus.

2. The transmission terminal as claimed in claim 1, wherein the determining includes determining whether a communicatively coupled external apparatus is the predetermined external apparatus based on a type, a name, a model number and identifier information acquired from the communicatively coupled external apparatus, or identifier information used by the predetermined external apparatus to perform communications.

3. The transmission terminal as claimed in claim 1,
wherein the process further includes receiving a setting to allow the transmission of the response when the transmission terminal is coupled to the predetermined external apparatus, and
wherein the determining includes executing the response when the setting is applied.

4. The transmission terminal as claimed in claim 1, wherein the predetermined external apparatus is a moving apparatus having a moving function controlled by communications from another apparatus.

5. The transmission terminal as claimed in claim 4, wherein the determining includes executing the response when a remaining amount of a battery used by the moving apparatus is a predetermined threshold or above.

6. The transmission terminal as claimed in claim 4, wherein the determining includes executing the response when the moving apparatus is not broken. 20

7. The transmission terminal as claimed in claim 1,
wherein the process further includes managing an automatic response allowable list including identifier information of other terminals as request source terminals, and
wherein the determining includes executing the response when the automatic response allowable list includes identifier information of the external terminal that has transmitted the start request.

8. The transmission terminal as claimed in claim 1, wherein the process further includes managing specified time period information, and
wherein the determining includes executing the response when a time at which the start request is received is included in the specified time period.

9. A method for executing an automatic response in a transmission terminal in transmission of content data in response to a start request for starting the transmission of the content data from a predetermined external apparatus, the method comprising:
determining whether the transmission terminal is coupled to a predetermined external apparatus; and
transmitting a response to the start request, when the transmission terminal is determined to be coupled to the predetermined external apparatus.

10. A non-transitory computer-readable recording medium storing a program which when executed by processors performs a process, the process comprising:
determining whether the transmission terminal is coupled to a predetermined external apparatus; and
transmitting a response to the start request, when the transmission terminal is determined to be coupled to the predetermined external apparatus.
